(19) United States
(12) Patent Application Publication
(10) Pub. No.: US 2012/0135366 A1
(43) Pub. Date: May 31, 2012

(54) EASY ORTHODONTIC SLIDER

(76) Inventor: Enis Yasar Guray, Ankara (TR)

(21) Appl. No.: 13/304,450

(22) Filed: Nov. 25, 2011

Related U.S. Application Data
(60) Provisional application No. 61/417,274, filed on Nov. 25, 2010.

(51) Int. Cl. A61C 7/28

(52) U.S. Cl. 433/13

(57) ABSTRACT

An orthodontic slider apparatus is disclosed. The orthodontic slider is used to apply intra or inter maxillary forces to distalize or mesialize teeth. The orthodontic slider of the current invention can easily be applied to the archwire of the fixed brackets of an orthodontic appliance without having to remove the archwire from the brackets. The slider utilizes self locking arms that allow it to easily attach to or detach from the archwire.

This application claims the benefit of U.S. Provisional Application No. 61/417,274 filed Nov. 25, 2010 which is herein incorporated by reference.

### FIELD OF THE INVENTION

The present invention relates generally to an orthodontic appliance. The orthodontic appliance is a slider that is used to apply intra or inter maxillary forces to distalize or mesialize teeth.

### BACKGROUND OF THE INVENTION

Sliding jigs have been used for many years in the orthodontic field for multiple purposes. For example, Thurow (1966), Tweed (1966), McLaughlin, and Bennet and Travisi (2001) used sliding jigs to apply intermaxillary elastic forces for orthodontic purposes. These jigs slide on a continuous archwire and transmit the desired force to the desired teeth. The forces that could be elastics or coil springs are not directly attached to the main archwire. Rather, they are attached to the hooks of the sliding jigs. They are usually used to distalize or to mesialize the posterior teeth.

Sliding jigs are used to transmit force between teeth. The device is simple, but effective for distalizing upper molars. The sliding jig can also be used for bilateral or unilateral corrections of teeth. Moreover, it can easily be added to a patient's current fixed orthodontic appliance without having to remove or modify any component of the existing appliance It can easily be constructed during a patient's appointment.

In traditional upper molar distalization techniques, patient co-operation is required with the use of headgear and/or elastics. Recently, there have been several different intraoral procedures introduced that minimize the need for this type of patient co-operation. In particular, mini implants or Temporary Anchorage Devices “TAD” are used in combination with coil springs in place of elastics.

In addition, sliding jigs that are applied on the buccal for distalization of posterior teeth (Kyurhim Chung, Seon-Hun Kim, Yoonah Kook, 2004) have been utilized to further minimize patient co-operation. In the prior art, sliding jigs are coupled to a continuous archwire. This requires that the main archwire be removed from the fixed orthodontic appliance and the sliding jig coupled to the main archwire. This application procedure significantly increases the amount of time that a patient must be in the doctor's office.

The current invention overcomes the disadvantages of the prior art. In particular, the current invention can be coupled to any archwire with its self-locking arms. As such, the archwire does not have to be removed from the fixed orthodontic appliance. This decreases the time involved in completing the procedure. The force application of the orthodontic appliance is facilitated while decreasing the patient's time in the doctor's office.

### SUMMARY OF THE INVENTION

The object of the current invention is to apply an orthodontic sliding jig to an archwire of a fixed orthodontic appliance without removing the archwire.

A further object of the current invention is to provide an orthodontic device that will facilitate a time efficient procedure for an orthodontic patient.

The novel features that are considered characteristic of the invention are set forth with particularity in the appended claims. The invention itself, however, both as to its structure and its operation together with the additional object and advantages thereof will best be understood from the following description of the preferred embodiment of the orthodontic appliance. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a front view of a preferred embodiment of the current invention.

FIG. 2 shows a side perspective view of the preferred embodiment of the current invention.

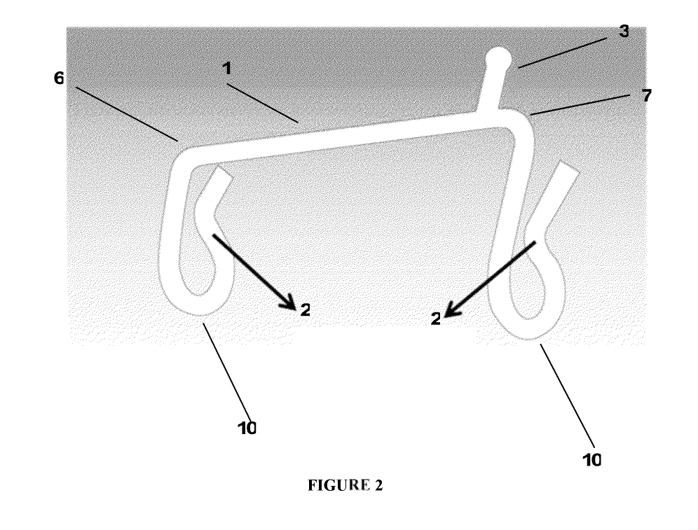

FIG. 3 shows the application of the invention on the retraction (upper jaw) and protraction (lower jaw) of posterior teeth.

FIG. 4 shows the frontal view of the slider.

FIG. 5 click-in-click-out secure clip action arm.

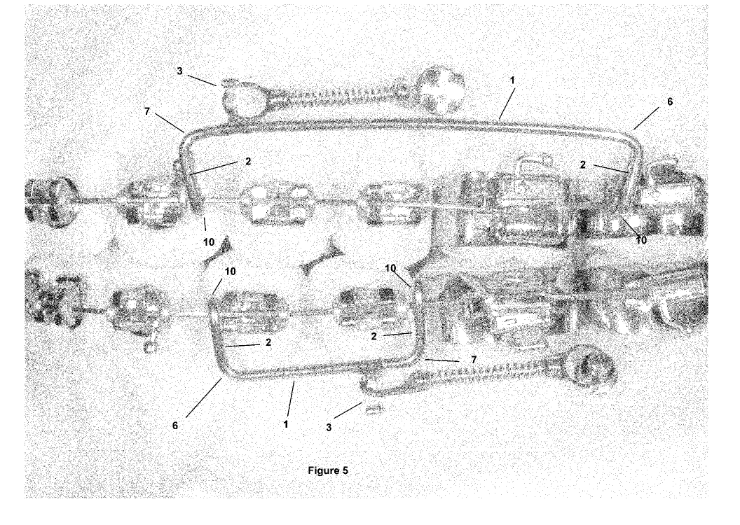

### DESCRIPTION OF PREFERRED EMBODIMENTS

The present invention relates to an orthodontic appliance that is used to distalize or mesialize teeth (i.e. Retract or protract teeth). The orthodontic appliance is a slider or sliding jig. The slider is used with orthodontic brackets that are fixed on a patient's teeth and the archwire that is run through and coupled with elastics to the brackets.

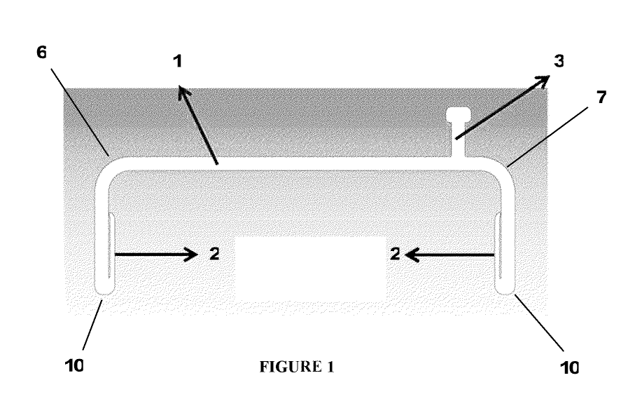

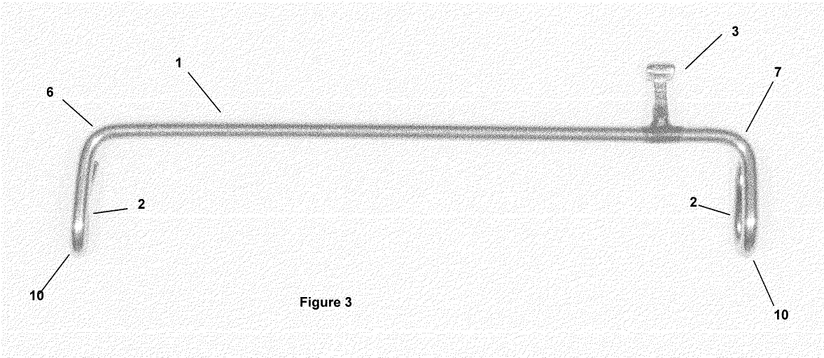

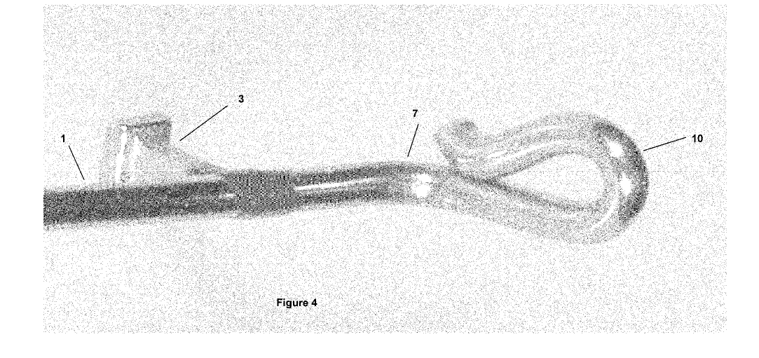

As seen in FIGS. 1 and 3, in the preferred embodiment of the invention, the slider includes a horizontal piece 1 with a first end 6 and a second end 7. The pair of self locking safety arms 2 extend downwardly from the horizontal piece 1 at its first end 6 and second end 7 such that the self locking safety arms 2 are parallel to each other in this configuration seen in FIG. 4.

In the preferred embodiment, the horizontal piece 1 also includes a ball hook 3 that extends upwardly from the horizontal piece 1 near the second end 5 of the horizontal piece 1. The ball hook 3 is the point of attachment on the slider for the force application as seen in FIG. 3. The coil springs are preferred as the force application because they apply continuous force which is critical to the stabilization of mini implants. Mini implants are temporary anchorage devices which are placed into the alveolar bone. They are used on different tooth movements such as distalisation, mesialisation, intrusion and extrusion of teeth. The stability of the mini implants during orthodontic treatment is critical. One of the factors affecting their stability is the usage of the continuous forces. For this reason Nickel-Titanium coil springs are preferred. The force application is the piece of the device that distalizes or mesializes (retracts or protracts) the teeth into position.

The self locking safety arms 2 of the device each include a free end 10 that are curved such that they are easily removable from an archwire that is used with brackets fixed to a patient's teeth for use in orthodontic procedures. The self locking safety arms 2 fit under the archwire and are snapped in to place. They can easily be attached to any archwire with their “click-in-click-out” secure clip action arms. In order to attach the slider to the arch wire, the slider is pushed over the arch wire. With this pressure, the self locking end will be opened and passed over the arch wire causing it to be removable coupled. In a similar way, the self locking safety arms 2 are removed from the archwire. Specifically, the slider is detached with opposite force application, by a simple pulling movement. Because the self locking safety arms 2 can be attached to and removed from the archwire without removing it from the brackets, the procedure is more time efficient, and reduces the potential of breaking or damaging other orthodontic equipment already on the patient.

In the preferred embodiment of the invention, the orthodontic slider device is made from Cr—Ni, titanium, or Stainless steel grade 304 or 316. After bending the stainless steel wire to the desired shaped, the vertical hooks are laser welded on to the horizontal piece 1 of the slider.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. An orthodontic slider apparatus comprising:
a. a horizontal piece with a first end and a second end;
b. a ball hook wherein the ball hook extends upwardly from the second end of the horizontal piece;
c. a pair of self locking safety arms with a free end wherein the self locking safety arms extend downwardly from the first end and the second end of the horizontal piece such that the self locking safety arms are parallel to each other;
d. wherein the orthodontic slider apparatus is removably coupled to an archwire that is attached to brackets fixed on teeth using the self locking safety arms; and
e. wherein a force application is removably coupled to the orthodontic slider apparatus using the ball hook such that the teeth are distalized or mesialized.

2. The orthodontic slider apparatus of claim 1 wherein the self locking safety arms are curved on the free end such that the arms hook on to the archwire.

3. The orthodontic slider apparatus of claim 1 wherein the force application is a coil spring.

4. The orthodontic slider apparatus of claim 1 wherein the orthodontic slider apparatus is made of Cr—Ni.

5. The orthodontic slider apparatus of claim 1 wherein the orthodontic slider apparatus is made of titanium.

6. The orthodontic slider apparatus of claim 1 wherein the orthodontic slider apparatus is made of stainless steel.
